(19) United States
(12) Patent Application Publication
(10) Pub. No.: US 2010/0147105 A1
(43) Pub. Date: Jun. 17, 2010

(54) HYBRID DRIVE TRAIN OF A MOTOR VEHICLE

(75) Inventor: Wolfgang SCHOEN, Kressbronn (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/631,187

(22) Filed: Dec. 4, 2009

(30) Foreign Application Priority Data
Dec. 15, 2008 (DE) 10 2008 054 637.2

(51) Int. Cl. F16H 57/02; F16H 57/04

(52) U.S. Cl. 74/606 R; 74/606 A

(57) ABSTRACT

A hybrid drive train of a motor vehicle with a transmission (1), a transmission oil sump (2) that is associated with the transmission (1), at least one electric machine, and a power electronics unit that is associated with the electric machine. A structural space (3) is provided for the power electronics unit, which is located under the transmission oil sump (2) of the transmission (1 ).

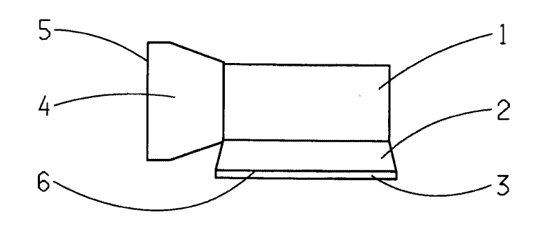

This application claims priority from German patent application serial no. 10 2008 054 637.2 filed Dec. 15, 2008.

### FIELD OF THE INVENTION

The present invention relates to a hybrid drive train of a motor vehicle.

### BACKGROUND OF THE INVENTION

In hybrid vehicles at least one electric machine is integrated in the drive train, which is controlled by an appropriate power electronics unit comprising an inverter.

From the prior art it is known to arrange the power electronics unit outside the transmission in a separate housing in the vehicle, and connect it to the electric machine by means of a three-phase or multi-phase cable.

Furthermore, solutions are known in which the power electronics unit is integrated in the drive train or in the transmission.

For example, from DE 10 2004 048 908 A1 a drive train for a vehicle is known, in which a converter bell is arranged between the internal combustion engine and a transmission, through which the drive shaft passes and in which a clutch device and an electric machine with at least one condenser and corresponding power electronics are integrated. In this case the condenser and the power electronics are arranged distributed in the direction around the outer circumference of the electric machine between the stator of the electric machine and the converter bell, and are in heat-conducting contact with the cooling system of the stator of the electric machine.

DE 10 2006 005 095 A1 describes a hybrid transmission with a transmission housing having on the input side a bell-like housing section, such that in the transmission housing there is arranged at least one electronic machine which is provided in order to feed drive energy into a torque path of the hybrid transmission or to extract mechanical energy from the torque path of the hybrid transmission and convert it to electrical energy.

In this case, to control or regulate the at least one electric machine an electric control/regulation device is provided, which is arranged in a radially outer area of the bell-like housing section in such manner that the control/regulation device extends over only part of the periphery of the bell-like housing section.

The solutions known from DE 10 2004 048 908 A1 and DE 10 2006 005 095 A1 have the disadvantage that maintenance, or replacement of the components of the power electronics unit, involve considerable effort and cost.

### SUMMARY OF THE INVENTION

The purpose of the present invention is to indicate a hybrid drive train of a motor vehicle with the power electronics unit of the at least one electric machine being arranged close to the electric machine, which enables maintenance or replacement of components of the power electronics unit to be carried out with little effort, and which is neutral in terms of structural space.

Accordingly, a hybrid drive train of a motor vehicle with a transmission oil sump associated with the transmission, at least one electric machine and a power electronics unit associated with the electric machine is proposed, in which the structural space provided for the power electronics unit is located under the transmission oil sump.

For this purpose the structural groups constituting the power electronics unit preferably have small structural height, so as not to unduly affect the ground clearance of the vehicle. According to a further development of the invention, the structural space for the power electronics unit can even be part of the transmission oil sump.

In a particularly advantageous embodiment of the invention, the area between the transmission oil sump and the power electronics unit is designed to have good thermal conductivity, this resulting in the advantage that no measures to ensure cooling of the power electronics unit, such as a further cooling circuit with a heat exchanger and pipework for the coolant medium, are needed.

As electrical connections, a multi-phase connection to the electric machine, the power connection to the DC intermediate circuit and/or a data connection to the outside, for example to a bus system are provided, such that according to the invention the multi-phase connection to the electric machine can be realized inside the transmission by means of prefabricated shaped components. Moreover, for the power connection to the DC intermediate circuit and for the outward data connection, corresponding connections can be provided at suitable points on the transmission; for example, these connections can be formed by means of a cable and plug, or by means of a plug provided directly on the transmission housing.

By virtue of the concept according to the invention, of a hybrid drive train with the power electronics unit arranged under or in the transmission oil sump in the immediate vicinity of the electric machine, on the one hand the connection between the electric machine is very short, which is also advantageous in relation to electromagnetic compatibility. On the other hand there is no need for connection cables, and this results in a substantial simplification of the system comprising the electric machine and the power electronics unit. By integrating prefabricated components in order to create the multi-phase connection to the electric machine in the transmission housing and in the transmission, assembly is simplified, the number of components is reduced and the assembly time is considerably reduced.

A further advantage of the concept according to the invention is that thanks to the structural-space-neutral arrangement of the power electronics unit, no additional structural space is needed. As a result, a hybridized transmission according to the invention can be fitted as an equipment variant in a vehicle having a transmission without hybrid drive, without having for this to make modifications in the vehicle to the structure of the transmission tunnel, the length of the drive train and the flange connections to the internal combustion engine and to the cardan shaft.

Moreover, due to the arrangement of the power electronics unit under the transmission oil sump, the transmission oil acts as a coolant which can advantageously also be used for cooling the power electronics unit, so that there is no need for additional measures for cooling the power electronics unit.

Related to this, under certain operating conditions, for example during a cold start, the power loss of the power electronics unit can be used to help heat the transmission oil circuit so as to bring it up to or keep it at operating temperature. This is particularly advantageous when, during low-load phases of the internal combustion engine, the electric machine is to replace it completely.

### BRIEF DESCRIPTION OF THE DRAWING

Below, an example of the invention is explained in more detail with reference to the attached FIGURE, which is a schematic representation of a transmission in which the structural space for the power electronics unit is located under the transmission oil sump.

### DETAILED DESCRIPTION OF THE PREFERRED EMBODIMENTS

In the attached FIGURE the transmission is indexed 1, the transmission oil sump 2, the transmission bell 4 and the flange 5 to the internal combustion engine (not shown). According to the invention the structural space 3 for the power electronics unit of the at least one electric machine of the drive train is located under the transmission oil sump 2. Preferably, the area 6 between the transmission oil sump 2 and the structural space 3 for the power electronics unit is made with good thermal conductivity so that there is no need for additional measures to ensure cooling of the power electronics unit.

### Indexes

1 Transmission
2 Transmission oil sump
3 Structural space for the power electronics unit
4 Transmission bell
5 Flange
6 Area between the transmission oil sump 2 and the structural space for the power electronics unit

1-6. (canceled)

7. A hybrid drive train of a motor vehicle comprising:
a transmission (1),
a transmission oil sump (2) associated with the transmission (1),
at least one electric machine, and
a power electronics unit associated with the electric machine, and
a structural space (3) being provided for the power electronics unit, which is located under the transmission oil sump (2) of the transmission (1).

8. The hybrid drive train according to claim 7, wherein the structural space (3) for the power electronics unit is part of the transmission oil sump (2) of the transmission (1).

9. The hybrid drive train according to claim 7, wherein an area (6) between the transmission oil sump (2) and the structural space (3) for the power electronics unit is designed to have good thermal conductivity, such that no additional measures are required to ensure cooling of the power electronics unit.

10. The hybrid drive train according to claim 7, wherein as electrical connections, at least one of a multi-phase connection to the electric machine, a power connection to a DC intermediate circuit and a data connection to the outside are provided.

11. The hybrid drive train according to claim 10, wherein the multi-phase connection to the electric machine is realized within the transmission by prefabricated shaped components.

12. The hybrid drive train according to claim 10, wherein the power connection to the DC intermediate circuit and the data connection to the outside are realized either by a cable and a plug, or by a plug located directly on the transmission housing.

13. A hybrid drive train of a motor vehicle comprising a transmission (1) with an oil sump (2), which is coupled to a lower side of the transmission (1), at least one electric machine with a power electronics unit, the power electronics unit being arranged in a structural space (3) located below the oil sump (2) of the transmission (1).

14. The hybrid drive train according to claim 13, wherein an area (6) between the oil sump (2) and the structural space (3) for the power electronics unit facilitates thermal conductivity between transmission oil in the oil sump (2) and the structural space (3) to ensure cooling of the power electronics unit.

15. The hybrid drive train according to claim 14, wherein the structural space (3) is integral with the oil sump (2).

16. The hybrid drive train according to claim 15, further comprising at least one of a multi-phase connection to the electric machine, a power connection to a DC intermediate circuit and a data connection to the outside.

17. The hybrid drive train according to claim 15, wherein the power connection to the DC intermediate circuit and the data connection to the outside are realized either by a cable and a plug, or by a plug located directly on the transmission housing.

18. A hybrid drive train of a motor vehicle comprising a transmission (1), an oil sump (2), an electric machine with an associated power electronics unit and a thermally conductive area (6), the power electronics unit is accommodated in a structural space (3), the transmission (1) is coupled to a top side of the oil sump (2) and the structural space (3) is coupled to a bottom side of the oil sump (2) opposite the transmission (1) with the thermally conductive area (6) being located between the oil sump (2) and the structural space (3) such that oil in the oil sump (2) contacts the thermally conductive area (6) and cools the power electronics unit in the structural space (3).
